(19) United States
(12) Patent Application Publication
(10) Pub. No.: US 2023/0182361 A1
(43) Pub. Date: Jun. 15, 2023

(54) MULTI-INPUT, MULTI-OUTPUT MANIFOLD FOR THERMOCONTROLLED SURFACES

(71) Applicant: National Research Council of Canada, Ottawa (CA)

(72) Inventors: Jean-Michel Lamarre, Boucherville (CA); Vincent Raymond, Terrebonne (CA)

(73) Assignee: National Research Council of Canada, Ottawa (CA)

(21) Appl. No.: 17/994,671

(22) Filed: Nov. 28, 2022

Related U.S. Application Data
(60) Provisional application No. 63/288,721, filed on Dec. 13, 2021.

(51) Int. Cl. B29C 45/73; B29C 45/26

(52) U.S. Cl. CPC B29C 45/7312; B29C 45/26; B29C 2045/7343

(57) ABSTRACT

A forming tool with forced thermal fluid-based spatio-temporal temperature control of a surface of the tool has a subsurface manifold underlying at least a part of a forming surface of the tool and a number P of at least 6 ports, each port fluid coupled respectively to the manifold via respective channels, where the ports exit the tool at disparate points, with each pair of ports in fluid communication via the manifold. This structure allows manifold path diversity for varying thermal fluid supply and drainage. The manifold may be reinforced.

### FIELD OF THE INVENTION

The present invention relates in general to forced thermal fluid systems for spatio-temporally resolved control over thermocontrolled surfaces (e.g. of dies, molds and other forming tools), and in particular to such a system comprising a single manifold (such as a conformal manifold) underlying the thermocontrolled surface with ports for a plurality of flow control elements operable to block or to fluid-couple to the manifold to a thermal fluid supply or drain.

### BACKGROUND OF THE INVENTION

It is common to provide conformal, or simply somewhat local, heating or cooling to thermocontrolled surfaces of molds and other forming apparata, by providing channels therein, and coupling the channels with supplies of heated or cooled (i.e. thermal) liquids (although gasses, which generally have lower thermal capacities, can also be used). A channel's form factor (length much greater than cross-section dimensions) impacts the temperature distribution with unwanted directionality. Most often, closed channels are provided from a single inlet, to a single outlet (without branching), although in some cases there are multiple inlets to channels, and/or multiple outlets so that a single channel branches and distributes the thermal fluid over a wider area, as these can improve uniformity of thermocontrol of the surface. Whenever there is a relatively large surface needing temperature control, or high spatial resolution of control, there are typically several to many such channels.

One problem with highly branched designs is maintaining a balance of pressures on the branches that ensure desired cooling in regions adjacent the branches. Even the best of designs may not function: initially, depending on fabrication tolerances; or after wear, or surface buildup, or if particulates are entrained in the liquid, the balance can be thrown off leading to unsatisfactory performance. So while an extent of thermally controlled regions can be substantially improved with highly branched designs, there can be challenges in their production and use. The limited number of paths and limited addressable area of the thermocontrolled surface, result in a limited effectiveness in controlling the temperature, both spatially and temporally. Once a channel is defined and the thermal medium and temperature are selected, space and time are linked: if fluid is sent to an inlet, it cools the whole path with the natural thermal gradients due to losses along the way. While flow rates and thermal fluid initial temperatures can be varied slowly, these are not sufficiently responsive to affect the surface for most purposes on most forming tools. There is little that can be done to adapt the channel for a different cooling/heating regime except to change pump rates, temperature, and possibly medium.

Increasing the number of channels and branches, while decreasing the diameter of channels, would obviously seem to provide better spatio-temporal control, but does not permit one to address complex spatio-temporal temperature profiles that were not envisioned in the initial design, such as required to address buildup or changing operating parameters or the thermal environment. While adding more separate channels and branches may provide more options for temperature control, forming tools become increasingly expensive and complicated to design and manufacture, are subject to greater risk of dysfunction if any debris or build up arises in the channels, and are further subject to leakage and premature failure, the more complicated the network, while still being prone to design flaws and low adaptability.

Applicant has found that there is no non-destructive, cost-effective way to validate final shapes of channels formed in forming apparata. Particularly for large forming tools of steel, which has a large attenuation coefficient, resolution limitations and artefacts are challenging, even when examining with relatively expensive techniques such as X-ray imaging. In summary, complicated network designs can be built with a defined tolerance, for a given price, but the actual flows through the channels and branches will vary due to small differences in tooling and how segments of the forming tool come together. If the system behaves unexpectedly, it can be very challenging to localize and correct the error.

For example, AT 515948 appears from its machine translation to teach, at paragraph 5, a molding machine with one cooling channel provided in the mold, the channel having a source, with the channel divided into a plurality of branches, and then recombined at a drain. This structure will provide the advantages of wider coverage of thermally controlled zones, but no independent control over cooling paths, and therefore very limited spatially or temporally resolved control over heat distributions.

Further, DE102018002614 to Marcus Rempe appears, from its machine translation, to teach a temperature control system for a molding tool with a fluid medium coupled to an inlet, distributed to a plurality of outlets. This reference appears to teach providing valves at each of a plurality of inlets to respective channels, to better balance the uniformity of temperature with sensor feedback. This valving independently controls flow rates through each channel, so spatial control is limited by the number of channels. According to Rempe's teachings, response times are substantially improved by collocating the thermal control medium at the forming apparatus, and removing long supply conduits.

A common assumption of the “manifolds” for cooling and heating channels running under thermocontrolled surfaces of forming tools has been a limited number of channels with a limited amount of branching. While producing and using forming tools with many such channels present substantial challenges, they are used where needed. A new type of forced thermal fluid control system is needed for better spatio-temporal control of more complex molds.

### SUMMARY OF THE INVENTION

The present invention is a reimagined forced fluid system for thermocontrol of a surface for a forming tool or apparatus (including the molten metal or plastic, or plastic resin injection molds of the prior art as well as a wide variety of dies bearing mold faces for liquid, semisolid, warm or cold solid forming, pressing, coining etc.). The forced fluid system includes features on forming apparata alone, including a manifold connected to an array of (at least 6) ports at different strategic locations relative to the thermocontrolled surface. Each port is adapted to be coupled to each other port via the manifold, and can be selectively coupled to one or more of a thermal fluid supply, and a drain by a flow control element, such as an electromechanical switch or valve. Collectively at least two, and more preferably many, ports are coupled to the thermal fluid supply and as many are coupled to the drain, so that effectively there are at least twice a square of the number of ports of unique thermal distribution patterns provided by collective control over all the flow control elements. While the number of channels was an important parameter of prior art systems for thermocontrolled surfaces, where each channel has a unique and separate paths between source and drain through the network, the term path is less satisfactory here, as each state of all flow control elements (except for a few redundancies) produces a unique spatio-temporal thermal distribution pattern that can be selected for an interval of time that corresponds with the control capabilities of the flow control elements, given that multiple ports can be used for supply and drain.

The manifold itself may have a large surface area that substantially underlies the mold face or forming surface that corresponds with the thermocontrolled surface. The manifold may be in the form of a cooling plane in some applications, but all of the advantages of the manifold being partially or fully conformal to the thermocontrolled surface known in the art recommend the use of at least partially conformal manifold configurations.

Some forming apparata are subject to high loads during forming processes. To avoid stress concentrations that arise from large surface area voids aligned with thermocontrolled surfaces, it may be desirable to reinforce the manifold, for example with an array of pillars, a lattice structure or scaffold, whether of unitized construction or as an assembly of members. The pillars may be provided by partially inserting one end of the pillar into a recess of the back-adjacent face of the manifold. The reinforcing structure may be simpler to manufacture and control tolerances for, than formed channels, and may be composed of a different material, such as a higher tensile strength material, than the forming apparatus, such that a material stiffness of the forming apparatus may be the same in the region of the manifold as it is on either side. One reinforcing structure is an array of Kagome-style spacers, that may or may not be coupled to form a sheet or truss series of strips, the coupling being preferably provided at a bottom or top edge of the sheet or strips. Any space-frame truss can be used alternatively. Another amenable structure that can be deployed is an expanded corrugated metal sheet with or without bracing strips to interlock adjacent ripples of the corrugation. Finally a lattice structure with a of stacking of layers of stiff rods or members, each layer oriented differently (preferably orthogonally) can be used, to provide a high stiffness, structurally sound reinforcement, but with a slightly higher flow resistance.

In one embodiment, the manifold is coupled to a periodic array of ports that has a uniform spatial density across a back of the forming tool (a face opposite the thermocontrolled surface). Of course the ports can alternatively be arrayed only on side edges of the forming tool if peripheral ports provide sufficient spatio-temporal control for a desired application, or on a combination of back and side surfaces. Furthermore, with a suitably supporting, sealed, tray on the back side (e.g. an additively manufactured or machined workpiece), the ports may be effectively relocated to a side edge of the forming tool where it meets the tray. The manifold provides a temperature controlled plane, layer, or subsurface chamber (below the thermocontrolled forming surface) which may be substantially or partially conformal with the mold face, interconnecting the ports with one another. At each port, or at least a substantial number of the ports, a respectively controlled flow control device is provided to selectively couple the port to one or more of: one or more thermal medium supplies, and a drain.

Naturally, any port with no flow control device, is temporarily, permanently, or semi-permanently sealed. Each port may only be closed, or open to one of: one or more thermal medium supplies, and the drain, for example if the flow control device at the port is a 2-way valve. Note that, herein, valves that are said to be “closed” operably may not be hermetically sealed. There are many valves that have some small measure of leakage in a closed state, and this may be advantageous to preventing pressure buildup and higher measures of control over equipment. More of consequence is where the leaking occurs. It may be preferable that leaking happens in one direction, e.g. from source to manifold, or manifold to drain, more preferably than source to drain, more preferably than manifold to ambience. Closed refers to creation of sufficient flow resistance relative to an open state to substantially alter flow through the port.

If each port is only selectively coupled to one conduit, be it a thermal fluid supply or the drain, the flow control element is essentially a valve. Closure of the valve makes the port effectively inactive in the manifold, and opening the valve conduit couples the port at that instant. The valve may have (continuously or discretely) graduated set of open states, for varying throughput, allowing for a more sensitive control.

Alternatively, the flow control device may be a multi-way valve or switch that has a state that blocks the port, and respective states that exclusively couple the manifold to each of the two or more conduits.

Each port, or each of the substantial number of ports, may have an identical multi-way valve coupled to the same set of fluid supplies and drain, or each port could have either a 1-way or 2-way valves. For example, the ports may be partitioned into: a first subset of 1-way couplings to drain; a second subset of 1-way couplings to a hot fluid supply; a third subset of 1-way couplings to a cold fluid supply; a fourth set of 2-way valves for coupling to drain or hot fluid supply, a fifth set of 2-way valves for coupling to hot or cold thermal fluid supply, a sixth set of 2-way valves for coupling to drain or cold fluid supply, and a seventh set of 3-way valves for coupling to drain, or hot, or cold fluid supplies, as this is the general case.

In general the invention may allow for an exponential number of flow states corresponding to the valve states at the ports provisioned with the flow control devices. Thus if there are only 15 of 100 ports with 3-way valves, each coupling the port to either a single thermal medium supply, or the drain, or blocking it, there are 3¹⁵=14,348,907 system states. However only configurations with one or more valve states open to drain, and one or more open to the supply would apply a unique heating/cooling flow. There are 3¹⁵−2¹⁶+1 (>14.2 M) of these.

If limited to 2-way valves, the substantial number of ports will be partitioned into drain-coupled and (one or more) source-coupled ports, and the partitioning will generally spatially distribute each type to avoid clustering of the same type of port, as this allows for best spatio-temporal thermal control. The exponential increase in number of system states doesn't rise as quickly, but with 10 source-coupled or blocked ports and 10 drain-coupled or blocked ports, there are (2¹⁰−1)²>1M system states, which provides more control options than required by most users, and far more than what is available in the prior art.

The key advantage of the technology is the ability to control the flow of fluid through the manifold by activating flow control elements at the ports to direct the thermal fluid as needed. If the forming process has a sufficiently slow cycle, coordinated timing of process parameters, such as injection, pressing, setting and ejection, repeated patterns of activations of the valves may be desired. Shortest paths between source and drain are particularly relevant to highest thermal response rate operations. Furthermore, lower pressure, and further separated source and drain ports can be used for lower frequency temperature fluctuations that may be overlaid with time division or spatial overlap of concurrent fluid paths. For low forming speed processes, it is possible to advantageously spatially vary the heating/cooling at respective stages in a forming process. In faster forming processes, specific cycle-averaged thermal conditions can be detected and addressed more responsively with this system. Rather than reliance upon channels formed at great expense in die materials (which are subject to unpredictable flow changes) the manifold interconnecting the ports has path redundancy and is only open to such issues adjacent the ports and their channels.

A copy of the claims as filed and as granted are incorporated herein by reference.

Accordingly, a forming tool with thermal fluid-based spatio-temporal temperature control is provided, the tool comprising: a subsurface manifold underlying at least a part of a thermocontrolled surface of the tool, the manifold bounded between a face-adjacent wall and a back-adjacent wall of the tool, and at least substantially surrounded by a peripheral wall; and a number P of at least 6 ports, each port fluid coupled respectively to the manifold via respective channels, the ports at disparate points, with each pair of ports in fluid communication via the manifold.

Preferably, there are at least 8, 9, 10, 12, 15, 20, or 50 ports, and the ports occupy at most 70% of the back-adjacent wall. The ports may be regularly arrayed with uniform spacing on the back-adjacent wall. Each of the channels extends through the peripheral wall or the back-adjacent wall to exit the tool.

The manifold is preferably reinforced with an open supporting structure that permits fluid circulation. The open supporting structure may comprise a number of members arrayed across the manifold, the members configured as: pillars, I-beams, spacers, or Kagome-shaped structures. Each of the members may be: joined to a common sheet, or to one or more strips; or adhered to the back-adjacent wall by welding, adhesive, mechanical fastener, or by additive manufacture.

The forming tool may be a mold of one of the following types: a liquid injection mold, a powder injection mold, a metal injection mold, a casting mold, or a stamping die.

The forming tool may further comprise: at least one thermal fluid supply; a drain; and a respective flow control element mounted to each one of the P ports, to couple the respective port to at least one conduit, be it one of the at least one thermal fluid supply, or the drain. Specifically at least a minimum number M of the ports are coupled via respective control elements to the drain, and at least M of the ports are coupled via respective control elements to the first supply, where M=2+floor (15(P−6)/4P). Each flow control element is preferably adapted to switch between at least two of the following states for a first of the at least one conduit to which it is coupled: a closed state where flow through the port is closed; a first open state where flow between the port and the first conduit has a first hydrodynamic resistance; and a second open state where flow between the port and first conduit has a second hydrodynamic resistance different by at least 10% than the first hydrodynamic resistance.

A set of the ports that selectively couple the manifold to the drain in dependence on a state of the flow control element, defines a drain set, just as a set of ports selectively coupling to a first of the at least one thermal fluid supply defines a first supply set. Both the drain set and the first supply set are preferably substantially dispersed. The sets may be substantially dispersed if, for each port in the first supply set: at least 2 of the 5 nearest ports are in the drain set; a mean distance to the 3 nearest ports of the first supply set is 15% greater than a mean distance to the 3 nearest ports of the drain set; or among the 5 nearest ports, a mean distance to the ports of the drain set is 15% less than the mean separation to the ports of the first supply set. The drain set and first supply set may be disjoint subsets of the set of all ports; may partition the set of all ports; may have a non-trivial set intersection; or one may be include the other.

At least one of the flow control elements may couple the port to both the drain and the first thermal fluid supply, and be adapted to switch between open states of exclusively one of the drain and first thermal fluid supply. Preferably each flow control element is adapted to switch to the closed state.

The forming tool may alternatively have the drain and first thermal fluid supply, and a respective flow control element mounted at at least two of the ports, adapted to switch between these three states: a first state that couples a first thermal fluid supply to the manifold; a second state that couples the manifold to a drain: and a third state wherein the port is closed.

At least two of the flow control elements may further be adapted to selectively couple a second thermal fluid supply to the manifold alternatively to coupling to the first thermal fluid supply, and to coupling to the drain. At least one of the flow control elements may have a number of states for opening to drain or supply, each state corresponding to a respective opening hydrodynamic radius.

Each flow control element is preferably a mechanical valve or switch electronically controlled by a common processor. The forming tool may further comprise a thermal treatment centre adapted to receive fluid from the drain, change a temperature thereof, and pump the product to the first thermal fluid supply; or a common processor for controlling each of the flow control elements.

The manifold is: closed, constraining the fluid to exit only via one of the ports; or is coupled by one or more channels to one or more other manifolds, and the manifold, channels and one or more other manifolds are collectively closed. In the alternative it could be open to an overpressure release valve, for example.

Also accordingly, a kit is provided for transforming a forming apparatus with thermal control channels into a multi-input, multi-output temperature controlled forming surface. The kit comprises at least 6 electromechanical flow controllers each flow controller adapted to couple the manifold to at least one of a first thermal fluid supply and a drain, for switching between at least two of the following states: a closed state where flow through the port is obstructed; a first open to source state where a first supplied thermal fluid may enter through the port at a first rate from the first thermal fluid supply; a second open to source state where a first supplied thermal fluid may enter through the port from the first thermal fluid supply at a second rate other than the first rate; a first open to drain state where thermal fluid may exit the manifold through the port at a third rate through the drain; and a second open to drain state where thermal fluid may exit the manifold through the port at a fourth rate other than the third rate.

The kit may further comprising a micromachining device adapted to be used alone or with other bits or materials, for at least partial insertion into a thermal control channel of the forming apparatus to join two or more separated thermal control channels to form a single manifold interconnecting at least 6 ports, the insertion provided by entry via existing ports of the separated channels of the forming apparatus, or by boring one or more new ports.

Finally, a method is provided for controlling a spatio-temporal thermal distribution on a mold face of a forming apparatus, the method comprising providing a forming tool according to any one of claims 10 to 19 with respective flow control elements coupled to respective conduits; and applying a signal to control each of the flow control elements while thermal fluid supplies and drain are operating, to control a temperature at the mold face.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1A is a top plan view of a mold half, provisioned with a multi-input, multi-output manifold for thermocontrol of a mold face in accordance with a first embodiment of the present invention;

FIG. 1B is a cross-section of the mold half of FIG. 1A through FIG. 1A along line BB;

FIG. 10 is back plan view of the mold half of FIGS. 1A,B featuring an array of ports and showing mold face features in ghost view;

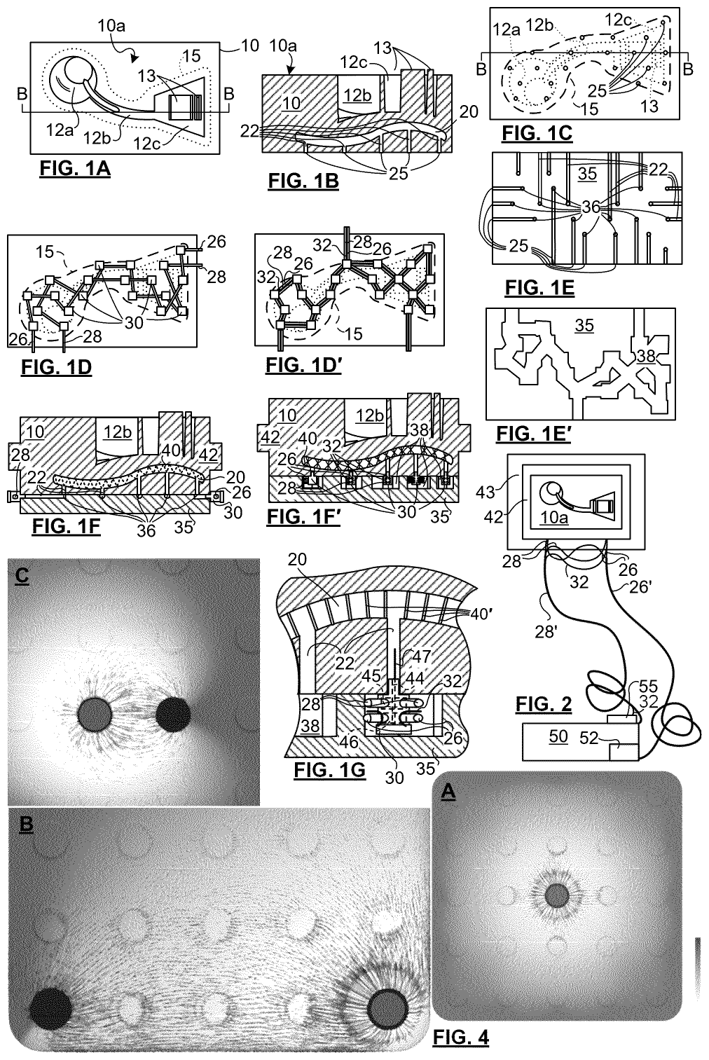

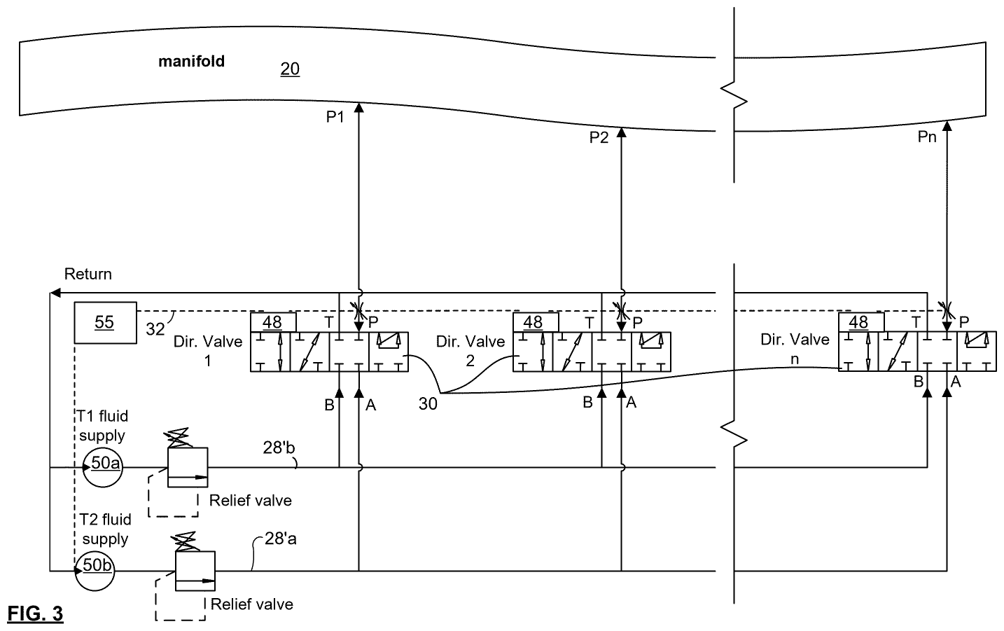

FIG. 1D is the back plan view of FIG. 10 with a plurality of 1-way flow control elements sealed and mounted to respective ports showing fluidic network connections in accordance with an embodiment of the present invention;

FIG. 1D′ is the back plan view of FIG. 10 with a plurality of 2-way flow control elements sealed and mounted to respective ports, featuring path redundency in accordance with an embodiment of the present invention;

FIG. 1E is a backing tray for sealed coupling to the back side of the mold half of FIG. 1C, to effectively displace to ports to side edge at an interface between the mold half and tray, and showing 90° bends for each channel at the interface;

FIG. 1E′ is a backing tray for protecting the 2-way flow control elements of FIG. 1D′ and improving stiffness of the forming tool for bottom and edge-based clamping;

FIG. 1F is a cross-section through FIG. 1A along line BB assembled with the backing tray of FIG. 1E featuring two 1-way flow control elements;

FIG. 1F′ is a cross-section through FIG. 1A along line BB assembled with the network of 2-way valves shown in FIG. 1D′ and the backing tray of FIG. 1E′;

FIG. 1G is an enlarged cut out view of the forming tool of FIG. 1F′ with a different reinforcement in the manifold, and an enlarged view of a 2-way valve, showing principal chambers thereof in ghost view, and a sensor mounted thereon;

FIG. 2 is an apparatus comprising the forming tool of FIG. 1F′ with one bundle removed, coupled to a thermal treatment centre with a pump and controller;

FIG. 3 is a schematic view of fluid, and electrical connections to ports of a manifold in accordance with an embodiment of the present invention, the system has both hot and cold thermal fluid supplies and drain; and

FIG. 4 is a panel of three images A,B,C showing thermal and fluid-dynamic simulated results for respective system states, the thermal modelling provided by a gray-scale marking provided by a same scale to the right of panel A, and the fluid-dynamic simulation illustrated by vectors, with larger flows identified by larger weight arrows.

### DESCRIPTION OF PREFERRED EMBODIMENTS

Herein a forming tool, and kit for transforming a forming tool with thermal control channels into a forming tool with a multi-input, multi-output temperature controlled forming surface is described, as well as a method for controlling a thermal distribution of a forming tool or apparatus, such as a mold.

FIGS. 1A,B,C are schematic top plan, cross-sectional side, and bottom plan views respectively of a first embodiment of a mold half 10 of the present invention. The mold half 10 has a mold face on a top surface 10a that consists of numerous curved recessed and protruding surfaces, and edges designed to define some part of a piece, the collection of which are referred to herein as features.

The specific shape shown is not designed to resemble any known part, and any similarity is unintentional, however the mold half can have substantial depth and variability in depth and can have abrupt edges and easier and more difficult regions for demolding. As shown, the mold face has a flat-bottomed cup area 12a joined by neck 12b to a base 12c having intrusions 13 that (as seen in FIG. 1B) protrude above a nominal height of the top surface 10a, though such intrusions are by no means common amongst mold halves. Furthermore the deep recesses between intrusions 13 may be infeasible for demolding certain metal parts, but may be acceptable e.g. for some resin-based plastic molding.

Surrounding the mold face, shown in ghost line, is a thermally controlled area 15 of the mold half 10. While the thermally controlled area encompasses the whole mold face in this embodiment, it need not cover the whole mold face as some parts of a mold face may be in greater need of enhanced temperature control, and not others. Furthermore, as shown, it is usual for thermal control to extend beyond the limits of the mold feature areas.

As seen in FIG. 1B, substantially underlying the thermally controlled area 15 is a single, connected manifold 20 to which numerous channels 22 are coupled. While only 5 channels 22 are in view along the section line BB, as can be seen in FIG. 10, which schematically illustrates a back surface of the mold half 10, there are 20 such channels in the illustrated embodiment, that are arranged on 6 equally spaced lines. The manifold 20 provides a plenum for thermal fluid that is shown somewhat as a conformal cooling manifold in that a mean distance from a floor of the mold face (where defined) to the manifold 20 (i.e. a nominal minimal thickness of the mold face above the manifold 20) varies across the mold face by less than twice a mean depth of the manifold 20. The depth of the manifold 20 is substantially uniform. Although this is expedient, it is by no means necessary. Each channel 22 communicates between the manifold 20 and a respective port 25.

As is well known in the art of conformal thermal control of molds, there is a trade-off between the closest approach between the channels and floor of mold (the nominal minimal thickness of the mold face above the manifold), as too thin a separation results in inferior strength of the mold, and too thick a separation reduces efficiency of the cooling. This trade-off is exacerbated by the enlargement and increased interconnection of channels to form the single connected manifold 20, and peaks with the unstructured, whole of area open plenum shown. Furthermore, the tradeoff becomes acute as the closer the thermal fluid gets to the formed material, the more effective the thermal control becomes. However, the fluid-based thermal control is of no use if the mold fails prematurely or the mold face deforms under thermal or mechanical loading during forming processes. As will be appreciated by those of skill in the art, mold halves are typically composed of particular materials chosen for longevity of the mold, costs, and stiffness used for forming molds for different processes and materials, and while the inclusion of a manifold may provide an impetus to use higher stiffness materials, to increase a plenum volume, it is expected to more often be cost efficient to reinforce the manifold with a scaffold, bridging structure, packing of high stiffness balls or cylinders, strip of joined supports or Kagome structures, space frame truss, or any sufficiently open (low hydrodynamic resistance) support structure.

FIG. 10 shows a full set of 20 ports 25 (of which only 5 are identified to avoid complicating further the image). The mold face features are shown in ghost view for context, and the outline of the thermal control region 15 is shown in dashed line. Thus the mold half 10 is shown with a novel manifold 20 that is believed to be unique in that it interconnects 6 or more ports permitting a large number of spatio-temporal thermal distributions to be applied at the mold face.

FIG. 1D schematically illustrates the back side of the mold half 10 with one flow control element 30 (of which only 5 are identified to avoid complicating further the image) in each port 25. Each port is sealed for a rated pressure in any one of a variety of manners known in the art. Half of the flow control elements 30 selectively couple a thermal fluid supply 26 with the respective port, in that the flow control element can either block the port, or couple it to the supply; and the other half selectively couple to the drain in like manner.

Each flow control element 30 may be a simple open/close valve, or may have a plurality of degrees of open states, each state corresponding with a respective pressure loss in flow across the valve (for example by varying hydrodynamic resistance), and further some of the flow control elements 30 may be of either kind. Once the hydrodynamic resistance is less than that of the fluid through the conduits 26/28, the flow control element is fully open (no further opening has any effect on flow rate). A small number, less than 20, more preferably less than 10, and most preferably 3-8 states of respective hydrodynamic resistance may be identified with distinct, open states of these flow control elements. The number of states of each valve greatly affects a number of thermal distributions applicable to the thermal control region by the system as a whole, at the expense of slightly more cumbersome control and costs of the system.

Each flow control element 30 shown couples two tube sections of the conduit to which it couples: i.e. either the supply 26 or the drain 28. This allows for a single serial conduit to sequentially feed each port 25, in dependence upon state of the flow control element. As such, each flow control element 30 illustrated has two tube coupling ends in communication with a first internal channel of the flow control element 30, a second internal channel coupled to the channel 22, and a sealed mechanical device for selectively interconnecting the two internal channels. Some flow control elements known in the art have only one opening to each internal channel, and it is trivial to provide T-couplers in the conduit 26,28 for each flow control element to provide an equivalent network.

The supply 26, as shown (just like the drain 28), happens to have 2 ends. Both ends of the supply 26 will come from a pump section of thermally treated fluid. While most often these fluids are high thermal transfer rate liquids, that are inert and have stable reliable rheology across the temperature range, they can also be gasses. Preferably the thermal fluid and manifold (with any reinforcement) and pump rates are selected to ensure that a flow regime through the manifold has a Reynolds number 1 to 1000 to avoid full turbulence. The two ends are not necessary as the second end can alternatively be a termination: the fluid can be fed from only one end. The first internal channels of all of the connected flow control elements 30 of the same conduit are in open fluid communication, regardless of the states of the other connected flow control elements. Thus the sealed mechanical devices are in parallel with the conduit 26,28. Likewise there could be any number of ends desired. In general, the more ends, the shorter the path between the supply/drain and the open flow control elements 30, which is advantageous for reducing thermal loss (particularly important for the supply 26), and fastest response time. The use of two ends is convenient as every flow control element 30 has a same number of couplers, and there is one redundant path to every port 25: if one tube section were to be blocked or constricted between two ports 25, the flow to no ports would be appreciably impaired, and there is very little penalty in tubing connections or complexity introduced by this redundancy. This is because flow through conduit 26,28 is not inherently directed flow (it can flow in either direction). Once one or several of the ports are open, unless there is some constriction, flow is balanced between both ends to meet the flow requirements.

As shown, the ports selectively coupled to drain (herein “drain-coupled”) and those coupled to supply (“supply-coupled”) partition the set of ports, and are equi-numerous. The drain-coupled set is reasonably uniformly distributed amongst the supply-coupled set and vice versa. In the illustrated embodiment, the nearest neighboring port of each port happens to not be a member of the same partition, although this is a stronger requirement than necessary. It would be expected that for each port: at most 3 of the 5 nearest ports are members of the same partition; a mean separation between the 5 nearest ports of the same partition is 15% greater than a mean separation between the 5 nearest ports of the opposite partition; or among the 5 nearest ports, a mean separation to the ports of the opposite partition is 15% less than the mean separation to the ports of the same partition. Such a distribution is preferred to facilitate a broadest range of thermal fluid distribution patterns, as will allow the system to apply varied response. However, it will be appreciated that a forming tool may have a larger number of ports than are usable, and an engineered solution to address a particular problem may be called for that does not require uniform distributions of drain- and supply-coupled sets. If a reconnection of ports to source and drain conduits is required, the system is as reconfigurable as the availability of ports.

FIG. 1E schematically illustrates a backing tray 35 with surface relief patterns defining one channel segment 22 extending from edge ports 25 to elbows 36 that align with previously identified ports 25 in FIG. 10. This backing tray 35 effectively elongates channel segments 22 that extend in the mold half's relief direction (mold depth) by coupling them at the elbows 36, to channel segments 22 running towards edges of the mold half 10. This advantageously translates the ports from back-side features to side edge features that are more accessible during forming operations, and minimizes a volume to be bridged by the tray 35 (increasing a load that may be passed through the tray).

FIG. 1F is a cross-section showing the tray 35 mounted to the mold half 10, and the extension of two of the channels 22, that are coupled to respective source 26 and drain 28 conduits by respective 1-way valves. For this embodiment, the channel segments 22 are well separated, except for crevice flow between the mold half 10 and tray 35. While this can be substantially reduced with a suitable pancake flange or seal, the above comments about sealing apply here again: it may not be necessary to preclude flow along this crevice, as long as flow resistance is sufficiently higher than flow through the manifold, as long as the inconvenience of leaking out of the system is prevented by a seal surrounding the interface at an outside periphery of the mold half 10 where it meets the tray 35. This seal may also conveniently provide a seal for flow control elements 30.

FIG. 1F further shows a support structure 40 for rigidifying the manifold 20. The illustrated structure is that of an expanded, corrugated sheet. The corrugation, in this case, is a map-fold providing tent structures of triangular cross-section running an extent of the manifold. It will be appreciated that further rigidification can be provided by providing a set of base and peak separating structures to isolate each tent structure from transverse movement, or with any transverse wiring or rod that extends through some of the expansion slots of the folded sheet structure to limit motion. The addition of reinforcing structures into the manifold will typically increase fluid resistance between arbitrary ports. It is naturally disadvantageous to system responsiveness to increase resistance too much, and doing so increases the mechanical work of pumping the thermal fluid. Nonetheless, some resistance may be advantageous to improve resolution, in that flow can be more tightly focused between the source and drain ports.

Finally, FIG. 1F shows mounting flange ears 42 that can be used in some mold half structures to increase a localization of load to the mold above the manifold 20, which is another way of reducing a load applied through tray 35. Tray 35 is shown to have the channels 22 of low depth relative to the thickness of the part, which also increases a force that can be communicated through this part.

FIGS. 1D′,E′,F′, schematically illustrate a variant of the embodiments of FIGS. E,F, but with a common mold half 10. In this embodiment, the tray 35 does not provide any type of seal, but merely provides a supported enclosure for tubing that defines conduits 26,28. If the thermal insulation value of the tubing is appreciably higher than that of channels 22 (which is preferable for the conduction to the thermo-controlled surface), this embodiment may be of higher thermal efficiency than the embodiment of FIGS. E,F, as the thermal fluid is provided more directly to the manifold 20.

That said, direct thermal contact between the supply tubing 26 and drain 28 is a short-circuit thermal bridge that extends over a large surface area with this embodiment. Thus while the network connections of the 2-way valve system shown in FIG. 1D′ are substantially reduced compared with FIG. 1D, it may require higher quality insulation of the tubing.

FIG. 1D′ has a network of side-by-side source and drain conduits 26,28 that may flow in the same or opposite directions at any instant, and not necessarily at the same rates. It has three ends for each conduit, and further has 3 minimal closed loop cycles, provided by adding connections above what is necessary to connect to each port 25. These 3 cycles provide path redundancy, and expedite delivery.

FIG. 1E′ shows a tray 35 with enlarged passages 38 to accommodate the thermal fluid ingress and egress network, and FIG. 1F′ shows the mold half 10, coupled with the thermal fluid ingress and egress network of FIG. 1D′, assembled within the tray of FIG. 1E′. Each flow control element 30 is schematically illustrated coupled to a pair of source and drain conduits 26,28, although minutiae of directions of these coupling segments are not represented. As can be seen from FIG. 1D′, one of the ports is shown coupled to 4 other ports, whereas others only to one.

In FIG. 1F, an arrangement of Kagome structures 40 is used to rigidify the manifold 20. Each Kagome structure 40 may be retained in place at either top or bottom end by a weld. Alternatively the Kagome structures, which would be difficult to tip or roll, may be allowed to slide. Further alternatively, the Kagome structures may be welded to a top or bottom sheets or strips, as long as the sheets or strips don't occlude openings to the channels 22. For this reason it may be preferred to have sheets or strips only on one side, nearer the thermocontrolled surface. Kagome structures offer excellent mechanical support with minimal fluid dynamic resistance. If the Kagome structures are multiplied to the point where the base and top structures meet, the structure may be more akin to a space-plane truss, which also is an excellent support structure that can be employed.

FIG. 1G is an enlarged view of a small part of a manifold with a tray 35 (unsealed) that encloses a 2-way flow control element 30 particularly useful for the present invention. The 2-way flow control element 30 has two couplers for supply 26, and two for drain 28. The two for each conduit are open connected to respective first and second internal channels within the body of the 2-way flow control element 30. A device selectively couples a third internal channel, open to the manifold 20 via channel 22, to at most one of the conduits 26,28. Thus the 2-way flow control element 30 is adapted to either block its port, or couple to either the drain 28 or the supply 26. While not shown, a thermal insulation barrier is preferably provided between the drain and supply conduits.

Applicant further notes that an embodiment intermediate those of FIG. 1F and FIG. 1F′ is equally envisaged. Instead of sealing the tray 35 and mold half 10, as was done in FIG. 1F, or providing of the flow control element 30 in the passage 38 of the tray, a pipe with right angle fitting is provided in the passages 38 (which can also be reduced in diameter accordingly to provide greater stiffness). The pipe is therefore sealed and open to the manifold at one end, and controlled by the flow control element at the other that is provided at a more accessible location, such as around the periphery of the mold half.

FIG. 1G shows an array of pillars 40′ used to reinforce. These pillars may be additively manufactured, built up from either part of the mold half 10 (mold-adjacent or back-adjacent), and advantageously the whole mold can be additively manufactured to avoid assembly and leakage problems. While the pillars are illustrated as simple structures, it will be appreciated that additive manufacturing, with a variety of techniques such as cold spray, and various powder bed forming techniques, permit much more intricate structures to be fabricated quickly and easily. For example, it is possibly easier to form thickened roots of these pillars at both ends, and narrowing of the structures in the middle, as this general strategy improves buckling resistance and off-axis stiffness, with much less flow resistance than simply thickening the pillars. A wide variety of reinforcements can be built into the manifold if it is additively manufactured.

FIG. 1G also show an electrical bus 32 which allows for communication of signaling between a thermal regulation controller (which may be integrated with a mold process controller, and/or a controller of a thermal control station, or may be a standalone controller). The bus communicates between a flow control circuit (not in view), which may be as simple as a switch circuit or as complicated as a processor. Power for the processor may be supplied via the bus 32. It is highly preferable that the flow control element 30 of the present invention be electronically controlled. A fully autonomous thermal regulation system is achievable for well characterized processes.

The flow control circuit, or bus 32 is preferably coupled to a sensor 47, which is shown extending toward the manifold 20. The sensor 47 may be a flow rate sensor, such as a mass, velocity, or volume flow sensor, and/or a thermocouple or a resistance-based thermometer (for fast temperature change detection). Direct thermal measurement can be particularly advantageous if read by the flow control circuit, as this allows the local control over locally sensed parameters, as well as those of some neighbouring flow control circuits, can provide a robust processing architecture that can handle multiple faults and exceptions, although any variety of processing architectures are equally practicable. For example, if sampling of the sensors and instructions to respective flow control circuits can be time divided via the bus, all the thermal control can be provided by a single processor, conveniently located at the thermal processing system, which can also control pump rates and communicate with, comprise, or be comprised by, a process controller.

FIG. 2 is a schematic top plan illustration of the mold half 10 with flange 42 resting on a base 43, with two paired conduit ends extending from a common side. The supply conduits 26 are separated from a main supply 26′ at the mold half 10 to minimize thermal losses, just where the drain conduits 28 are joined to drain main 28′. Drain main 28′ is coupled to a drain inlet of a thermal treatment system 50, that comprises an insulated chamber for heating or cooling (including compressing or expanding the fluid, particularly if a gaseous medium is used) the thermal fluid until it has the right temperature for exiting to the main supply 26′. A pump 52 is used to control pump rate, energy supplied, or work done to maintain the thermal fluid within an established pressure supply and temperature range, that may depend on current demand by the process. A controller 55 receives the electrical leads 32 that are bundled with the drain main 28′, which allows the controller 55 to regulate temperature, pump rate, as well as the states of each of the flow control elements 30.

FIG. 3 is a schematic illustration showing an array of n ports (P) in a line coupled to a manifold 20. There may by m many such lines for m×n ports. Schematic switches show the allowed states of the 4-way 4 position switches 30, which include only coupling to the manifold, or no coupling. Specifically there are two thermal supplies (A and B), which may be hot and cold, respectively, or may be normal hot/cold and exceptionally hot/cold. Electrical control lines are shown dashed, and the controller 55 is separate from the two-station thermal treatment system (50a,b). Each has a relief valve.

The 4-way 4 position switches 30 are shown only with switching capability, but a variable flow resistance is coupled to the switch 30 at each port P, to further allow the controller 55 to throttle the flow through each port independently.

Control exerted by the controller may be assisted by the usual PID control algorithms, or by artificial intelligence driven by inputs and output response, where the inputs are control states of the flow control elements, temperature and pump rates of the thermal treatment system, and state of process in a process model, and the outputs may be quality of parts, demolding issues, or particular flaws.

### EXAMPLES

To demonstrate the present invention, simulation results were produced with a multi-physics finite element simulator that modelled transient thermodynamics and fluid dynamics of a simple 25 port thermal control manifold having a regular array of ports to a square manifold. The dimensions were 250×250 mm, virtually filled with a fluid with physical properties (density, viscosity, specific heat and conductivity) of water. The boundary conditions set for the manifold were isothermal. In the examples the manifold was initially set at a maximum and uniform temperature, and the image shows flow rates after 6 s. The thermal fluid supplied was a low temperature fluid source. The simulated switch operation was Boolean, each port fully opened or closed states were predefined. Injected fluid effectively cooled down specific region according to the selected configuration.

FIG. 4A is a simulation output showing the simulated structure in plan view. The whole structure is shown in a transient state with the centre opening acting as the inlet connected to the thermal fluid supply, and all the other ports are connected to the drain. The resulting profile is close to a Gaussian distribution concentric to the manifold centre. The arrow glyphs shows flow patterns with a length proportional to the velocity magnitude of the fluid. In this configuration the flow rate is strongest around the centre opening, and the 4 nearest neighbours are the dominant drains. The gray-scale image illustrates temperature as a function of position within the virtual manifold. A radius curvature of the opening of the channels to the manifold can be seen in the drawings.

FIG. 4B is a simulation output showing a bottom part of the simulated structure in plan view, with some magnification according to a second thermal distribution pattern. The second thermal distribution pattern produces a vertical thermal gradient is achieved with the bottom corner ports being respectively in the open to thermal fluid and open to drain states while the 23 other ports are closed.

FIG. 4C is a simulation output showing thermal and fluid-dynamic simulated results for a third thermal distribution pattern produced by using two central neighbouring ports respectively as source and drain, with all other ports closed. In this configuration, the thermally affected zone surrounds the two openings for a more localized, non-uniform, tailored heat transfer.

The described invention has been shown with the forming tool bearing a manifold with multiple input ports and multiple output ports. It will be appreciated by those of skill in the art that a wide variety of molds and other forming apparata can benefit from the present invention: including extremely high temperature, high pressure molds, such as those used in powder metallurgy; high temperature low pressure molds such as semisolid injection molding; to moderately high temperature low or higher pressure plastic injection molding apparata. Forming processes with a cycle time of seconds to hours or longer can all benefit, but particularly forming processes with cycle times on the order of one minute are particularly advantageous for temporal response of feedback that allows for a change in the thermal fluid distribution within a single cycle.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A forming tool with thermal fluid-based spatio-temporal temperature control, the tool comprising:
a subsurface manifold underlying at least a part of a thermocontrolled surface of the tool, the manifold bounded between a face-adjacent wall and a back-adjacent wall of the tool, and at least substantially surrounded by a peripheral wall; and
a number P of at least 6 ports, each port fluid coupled respectively to the manifold via respective channels, the ports at disparate points, with each pair of ports in fluid communication via the manifold.

2. The forming tool according to claim 1 wherein ports occupy at most 70% of the back-adjacent wall.

3. The forming tool according to claim 1 wherein each of one or more channels extend through: the peripheral wall; or the back-adjacent wall.

4. The forming tool according to claim 1 wherein there are at least 8, 9, 10, 12, 15, 20, or 50 ports.

5. The forming tool according to claim 1 wherein the ports are regularly arrayed with uniform spacing on the back-adjacent wall.

6. The forming tool according to claim 1 wherein the manifold is reinforced with an open supporting structure that permits fluid circulation.

7. The forming tool according to claim 6 wherein the open supporting structure comprises a number of members arrayed across the manifold, the members configured as pillars, I-beams, spacers, or Kagome-shaped structures.

8. The forming tool according to claim 7 wherein each of the members are: joined to a common sheet, or to one or more strips; or adhered to the face- or back-adjacent wall by welding, adhesive, mechanical fastener, or by additive manufacturing.

9. The forming tool according to claim 1 wherein the tool comprises a mold of one of the following types: injection mold, powder injection mold, metal injection mold, casting mold, or a stamping die.

10. The forming tool according to claim 1 further comprising:
at least one thermal fluid supply;
a drain; and
a respective flow control element mounted to each one of the P ports, to couple the respective port to at least one conduit, be it one of the at least one thermal fluid supply, or the drain, with: at least a minimum number M of the ports coupled via respective control elements to the drain, and at least M of the ports coupled via respective control elements to the first supply, where M=2+floor (15(P−6)/4P);
where each flow control element is adapted to switch between at least two of the following states for a first of the at least one conduit to which it is coupled:
a closed state where flow through the port is closed;
a first open state where flow between the port and the first conduit has a first hydrodynamic resistance; and
a second open state where flow between the port and first conduit has a second hydrodynamic resistance different by at least 10% than the first hydrodynamic resistance.

11. The forming tool according to claim 10 wherein:
a set of the ports that selectively couple the manifold to the drain in dependence on a state of the flow control element defines a drain set, just as a set of ports selectively coupling to a first of the at least one thermal fluid supply defines a first supply set;
both the drain set and the first supply set are substantially dispersed in that for each port in the first supply set:
at least 2 of the 5 nearest ports are in the drain set;
a mean distance to the 3 nearest ports of the first supply set is 15% greater than a mean distance to the 3 nearest ports of the drain set; or
among the 5 nearest ports, a mean distance to the ports of the drain set is 15% less than the mean separation to the ports of the first supply set; and
the drain set and first supply set: are disjoint subsets of the set of all ports; partition the set of all ports; have a non-trivial set intersection; or are mutually inclusive.

12. The forming tool according to claim 10 wherein at least one of the flow control elements couple the port to both the drain and the first thermal fluid supply, and is adapted to switch between open states of exclusively one of the drain and first thermal fluid supply.

13. The forming tool according to claim 10 wherein each flow control element is adapted to switch to the closed state.

14. The forming tool according to claim 1 further comprising:
at least one thermal fluid supply;
a drain; and
a respective flow control element mounted at at least two of the ports, adapted to switch between these three states: a first state that couples a first thermal fluid supply to the manifold; a second state that couples the manifold to a drain: and a third state wherein the port is closed.

15. The forming tool according to claim 10 wherein at least two of the flow control elements further selectively couples a second thermal fluid supply to the manifold alternatively to coupling to the first thermal fluid supply, and to coupling to the drain.

16. The forming tool according to claim 10 wherein at least one of the flow control elements has a number of states for opening to drain or supply, each state corresponding to a respective opening hydrodynamic diameter.

17. The forming tool according to claim 10 wherein each flow control element is a mechanical valve or switch electronically controlled by a common processor.

18. The forming tool according to claim 10 further comprising: a thermal treatment centre adapted to receive fluid from the drain, change a temperature thereof, and pump the product to the first thermal fluid supply; or a common processor for controlling each of the flow control elements.

19. The forming tool according to claim 14 wherein the manifold is: closed, constraining the fluid to exit only via one of the ports; or is coupled by one or more channels to one or more other manifolds, and the manifold, channels and one or more other manifolds are collectively closed.

20. A kit for transforming a forming apparatus with thermal control channels into a multi-input, multi-output temperature controlled forming surface, the kit comprising at least 6 electromechanical flow controllers each flow controller adapted to couple the manifold to at least one of a first thermal fluid supply and a drain, for switching between at least two of the following states:
a closed state where flow through the port is obstructed;
a first open to source state where a first supplied thermal fluid may enter through the port at a first rate from the first thermal fluid supply;
a second open to source state where a first supplied thermal fluid may enter through the port from the first thermal fluid supply at a second rate other than the first rate;
a first open to drain state where thermal fluid may exit the manifold through the port at a third rate through the drain; and
a second open to drain state where thermal fluid may exit the manifold through the port at a fourth rate other than the third rate.

21. The kit according to claim 20 further comprising a micromachining device adapted to be used alone or with other bits or materials, for at least partial insertion into a thermal control channel of the forming apparatus to join two or more separated thermal control channels to form a single manifold interconnecting at least 6 ports, the insertion provided by entry via existing ports of the separated channels of the forming apparatus, or by boring one or more new ports.

22. A method for controlling a spatio-temporal thermal distribution on a mold face of a forming apparatus, the method comprising:
providing a forming tool according to claim 10 with respective flow control elements coupled to respective conduits; and
applying a signal to control each of the flow control elements while thermal fluid supplies and drain are operating, to control a temperature at the mold face.
